(19) United States
(12) Patent Application Publication
(10) Pub. No.: US 2012/0158686 A1
(43) Pub. Date: Jun. 21, 2012

(54) Image Tag Refinement

(75) Inventors: Xian-Sheng Hua, Beijing (CN); Dong Liu, Hefei (CN); Meng Wang, Singapore (SG); Hong-Jiang Zhang, Beijing (CN)

(73) Assignee: MICROSOFT CORPORATION, Redmond, WA (US)

(21) Appl. No.: 12/971,880

(22) Filed: Dec. 17, 2010

(51) Int. Cl. G06F 17/30

(52) U.S. Cl. 707/706; 707/754; 707/736; 707/748; 707/E17.108; 707/E17.059

(57) ABSTRACT

A computing device configured to determine a subset of the tags associated with at least one image of a plurality of received, tagged images is described herein. The computing device performs the determining based on one or more measures of consistency of visual similarity between ones of the images with semantic similarity between tags of the ones of the images.

### BACKGROUND

With the advent of the Internet, users are increasingly sharing images with one another. Often, these images are shared through social networks, personal web pages, or image search services that allow users to share pictures. Because the web sites offering these images often store a vast number of images, mechanisms for searching for and retrieving images have been developed. One such mechanism utilizes low level features of the images themselves, categorizing images by their low level features and associating the features with searchable descriptors. Another mechanism utilizes image tags, such as image descriptors provided by users. These tags often include terms associated with the content of an image, such as “dog” for a picture of a dog. Tags also include other types of descriptors, such as a verb describing what is happening in a picture (e.g., “jumping”), an adjective (e.g., “beautiful”), or a term meaningful only to the user doing the tagging (e.g., a name of the dog). Also, terms are often erroneously applied to images (e.g., “car” for a picture of a boat).

Typically, users looking for images use common terms such as “dog” for their image queries. Users typically do not submit terms describing only an action or adjective without reference to some subject or object. Users also do not submit names or nicknames in queries unless the users know the person or thing being searched for. Thus, a great number of image tags are not helpful in finding the images they are associated with. Also, because some image tags are mistakenly applied to a wrong image, search results often include images of persons, objects, or locations different from what the user is looking for.

Another issue with image tagging is that the set of tags for an image often includes only one or two terms that a user might search for. Other terms (e.g., “canine” for a dog) that a user might submit in a search query are not associated with an image that they describe. Thus, users may submit queries but not receive as image search results a large number of the images that are associated with their search queries.

### SUMMARY

To improve the sets of tags associated with images, a computing device is configured to determine subsets of image tags based at least in part on measures of consistency of visual similarity between images with semantic similarity between tags of the images. Tags not belonging to the subsets are removed. By utilizing consistency of visual similarity with semantic similarity, mistakenly applied tags are removed from images. Consistency of visual similarity with semantic similarity may also be used to add tags to images that are related to image content but which have yet to be applied to the images. Also, the computing device may be configured to filter image tags based on classifications of the tags, such as “noun” or “verb,” or to filter based on associations between tags and categories. Further, the remaining subsets of tags may be enriched by the computing device, which may be configured to add synonyms or categories associated with the tags of the subsets of tags as additional tags of the images. The resulting tags are then applied to their associated images and used in an image search service, enabling users to better find the images they are searching for.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 is a block diagram showing an overview of computing device modules configured to determine filtered, refined, and enriched image tags, in accordance with various embodiments.

FIG. 2 is a block diagram showing an example computing device, in accordance with various embodiments.

FIG. 3 is a flowchart showing example operations for filtering image tags, determining a subset of image tags, and adding synonyms and categories of image tags as additional image tags, in accordance with various embodiments.

FIG. 4 is a flowchart showing example operations for filtering image tags by using classifiers and associations between tags and categories, in accordance with various embodiments.

FIG. 5 is a flowchart showing example operations for determining a subset of image tags based at least on consistency between visual similarity and semantic similarity, in accordance with various embodiments.

FIG. 6 is a block diagram showing an example implementation using the refined image tags in an image search service, in accordance with various embodiments.

### DETAILED DESCRIPTION

Described herein are techniques for refining image tags to produce a set of tags that more accurately correspond to the contents of the images. As used herein, “refining” refers to determining a subset of an image's tags based at least in part on measures of consistency of visual similarity between images with semantic similarity between tags of the images. “Refining” also includes adding tags to an image based on the measures of consistency (e.g., tags belong to other images that are determined to be associated with the content of the image they are added to). Tags in the determined subset are retained or “retagged” (i.e., reapplied) to the image, and tags of the image that are not in the determined subset are removed by deleting or disassociating the tags from the image. Also, tags added as part of the refining are included in the subset.

In some implementations, prior to refining the image tags, the image tags are filtered. Filtering the image tags may include removing tags based on classifiers of the tags (e.g., removing tags that are verbs or adjectives) or based on a lack of associations between the tags and categories. For example, if a tag is not found in a category hierarchy derived from a knowledge base, the tag is removed.

Further, after refining the tags, the subsets of tags may be enriched by adding further tags to the images. Enriching may include adding synonyms of tags found in the subset of tags or adding categories associated with the tags found in the subset of tags as further tags of the image.

In various implementations, the subsets of tags and added tags are then used with their associated images by an image search service to enable users of the search service to receive image search results that more accurately match their queries. By utilizing the refined and added tags, the search service increases the accuracy of the matches between the tags and images and thus provides better image search results.

In some implementations, the filtering, refining and enriching are performed by the image search service or by another computing device that provides the refined and added tags to the image search service.

### Overview

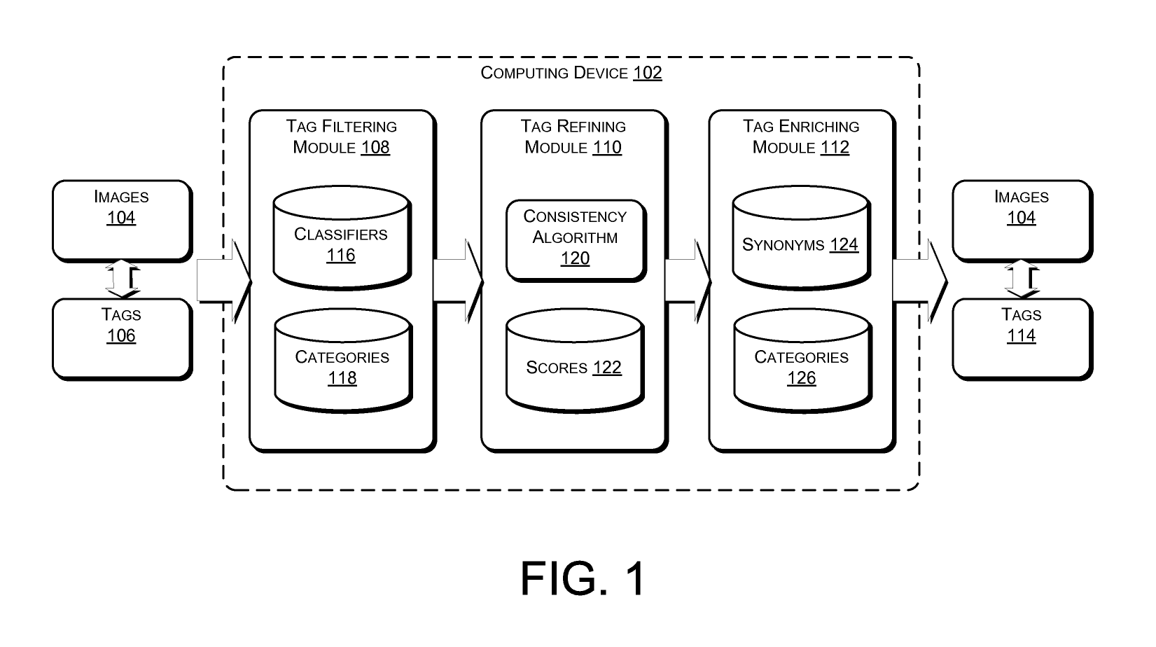

FIG. 1 shows an overview of computing device modules configured to determine filtered, refined, and enriched image tags, in accordance with various embodiments. As shown in FIG. 1, a computing device 102 receives images 104 and tags 106 that are associated with the images 104. The computing device 102 then utilizes a tag filtering module 108, a tag refining module 110, and a tag enriching module 112 to filter, refine, and enrich the tags 106, thereby producing tags 114. The tag filtering module 108 performs the filtering with reference to classifiers 116 and categories 118. The tag refining module 110 utilizes a consistency algorithm 120 to produce confidence scores 122. The confidence scores 122 in turn are used to determine subsets of tags 106 and to remove tags 106 not belonging to the subsets. The tag enriching module 112 then utilizes data associated with synonyms 124 and categories 126 to add further tags 114 to the tags 106 remaining in the subsets of tags.

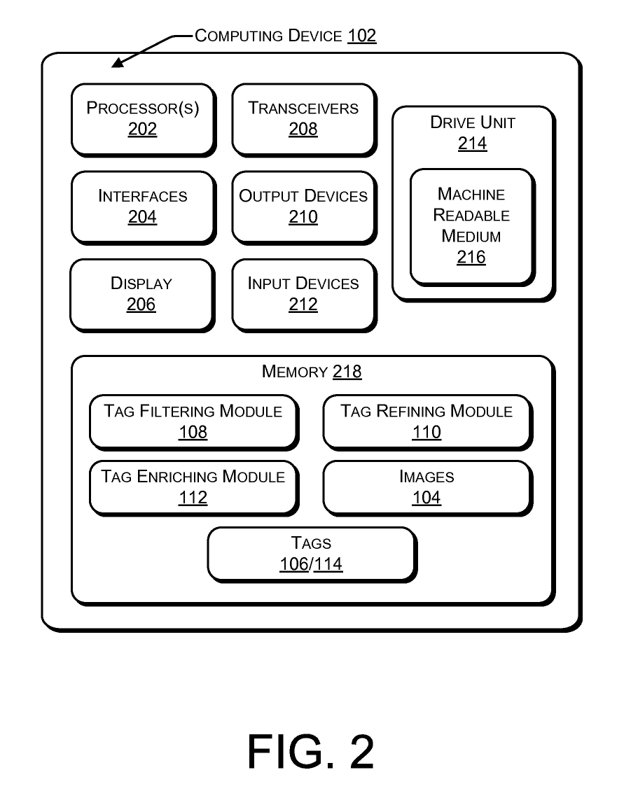

In various embodiments, the computing device 102 may be any sort of computing device. For example, the computing device 102 may be a personal computer (PC), a laptop computer, a server or server farm, a mainframe, or any other sort of device. In one implementation, the computing device 102 represents a plurality of computing devices working in communication, such as a cloud computing network of nodes. An example computing device 102 is illustrated in FIG. 2 and is described below in greater detail with reference to that figure.

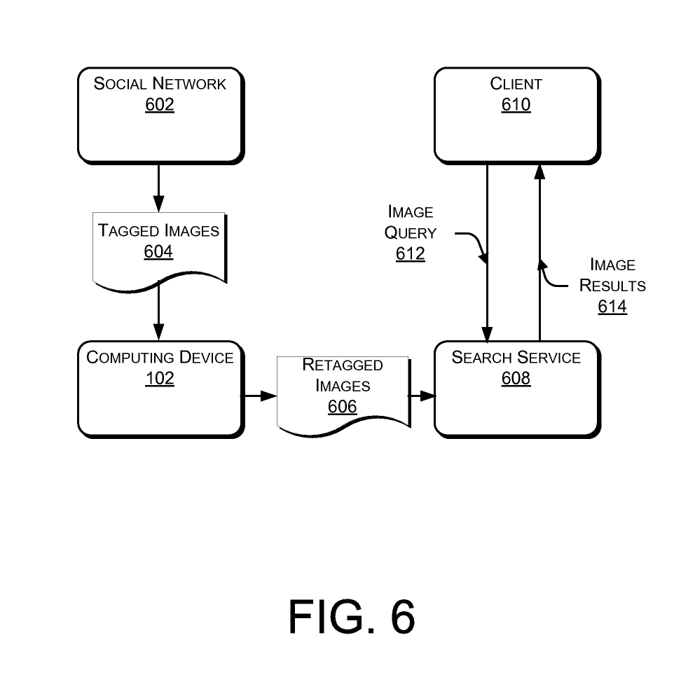

As shown in FIG. 1, the computing device 102 receives images 104 and their associated tags 106. In some embodiments, these images 104 and tags 106 may be stored locally on the computing device 102 and may be received from another program or component of the computing device 102. In other embodiments, the images 104 and tags 106 may be received from another computing device or other computing devices. In such other embodiments, the device or devices and the computing device 102 may communicate with each other and with other devices via one or more networks, such as wide area networks (WANs), local area networks (LANs), or the Internet, transmitting the images 104 and tags 106 across the one or more networks. Also, the other computing device or devices may be any sort of computing device or devices. In one implementation, the computing device or devices are associated with an image search service or a social network. Such devices are shown in FIG. 6 and described in greater detail below with reference to that figure.

In various implementations, images 104 may be any sort of images known in the art. For example, images 104 could be still images or frames of a video. The images 104 may be of any size and resolution and may possess a range of image attributes known in the art.

The tags 106 are each associated with one or more images 104 and are textual or numeric descriptors of the images 104 that they are associated with. For example, if image 104 depicts a dog looking at a boy, then the tags 106 for that image 104 may include “dog,” “boy,” “Fido,” “Lloyd,” “ruff,” “staring,” “friendly,” “2,” or any other terms, phrases, or numbers.

The images 104 and tags 106 may be received in any sort of format establishing the relations between the images 104 and tags 106. For example, the images 104 may each be referred to in an extensible markup language (XML) document that provides identifiers of the images 104 or links to the images 104 and that lists the tags 106 for each image 104.

In various embodiments, prior to refining the tags 106, the tag filtering module 108 (hereinafter “filtering module 108”) filters the tags 106. A number of the tags 106 may be “content-unrelated tags,” including signaling tags like “delete me” or emotional tags such as “best.” Such tags 106 can introduce significant noise to learning processes, such as those of the tag refining module 110. Thus, the computing device 102 utilizes the filtering module 108 to remove these “content-unrelated tags” prior to the processing of the tags 106 by the tag refining module 110.

In some implementations, the filtering is based at least in part on classifiers or associations between the tags 106 and categories. Each tag 106 may be associated with a “part of speech” or other sort of classifier in a data store of classifiers 116. The data store of classifiers 116 may be a database, a file, or any sort of data structure relating tags to classifiers. For instance, the tag “dog” may be associated with the classifier “noun” and the tag “2” with the classifier “number.” Based on the tags 106 and the data store of classifiers 116, the filtering module 108 removes tags 106 that are associated with certain classifiers in the data store of classifiers 116. In some implementations, the filtering module 108 removes tags 106 that are classified as verbs, adjectives, adverbs, and numbers or only retains tags 106 that are classified as nouns.

Also, the filtering module 108 may determine the presence or lack of associations between the tags 106 and categories 118. The categories 118 may comprise a category hierarchy derived from a knowledge base or provided by a knowledge base. For example, the WordNet™ knowledge base provides a category hierarchy that arranges categories into groups such that a core set of highest level categories are related directly or indirectly to every other category. Example highest level categories could include “color,” “thing,” “artifact,” “organism,” and “natural phenomenon.” Of these “organism” could be related to “animal,” “plant,” etc., “animal” could in turn be related to “mammal,” “mammal” to “canine,” and “canine” to “dog.” Each highest level category is then related to n other categories, each of those n categories to m categories, and so on. Such a provided or derived category hierarchy, then, may comprise the categories 118.

The filtering module 108 utilizes the category hierarchy comprising the categories 118 to determine if the remaining tags 106 are included or in some way connected to the categories 118. Returning to the above example, the tag 106 “dog” is included among the categories 118 and is associated by a chain of categories to a highest level hierarchy. Thus, “dog” would be retained as a tag 106 and would not be removed by the filtering module 108. Another tag 106 might not be found among the categories 118 but might be a synonym of one of the categories 118. In some implementations, such a tag 106 may also be retained. Other tags 106, such as “Meredith Vieira,” may not be found among the categories 118 and may not be in any way associated with the categories 118. Upon determining that there is no association, the filtering module 108 may remove the tag 106 by deletion or disassociation.

In various implementations, the tag refining module 110 (hereinafter “refining module 110”) determines subsets of tags 106 and removes tags 106 not belonging to the subsets. The refining module 110 receives the tags 106 from the filtering module 108, with the tags 106 received by the computing device 102 having been filtered to a “content-related” set of tags 106. In other implementations, the tags 106 may not have been first filtered by a filtering module 108.

To refine the tags 106, the refining module 110 utilizes a consistency algorithm 120 to determine confidence scores 122 for each combination of tag 106 and image 104. Each tag 106 is retained for or added to an image 104 where the confidence score 122 exceeds a threshold. Tags 106 that are associated with confidence scores 122 below the threshold for images 104 are removed from the images 104 by deletion or disassociation. The remaining tags 106—both those retained and those added—comprise the subsets of tags 106 for the images 104, at least one subset for each image 104. The confidence scores 122 may be represented by a matrix with each entry in the matrix corresponding to an image-tag pair, the matrix representing possible and actual combinations of tags 106 and images 104. The confidence scores 122 represented in the matrix may be given in percentages, decimals, or other weighted or unweighted numerical values.

In determining the confidence scores 122, the consistency algorithm 120 determines measures of consistency of visual similarity between ones of the images 104 with semantic similarity between tags 106 of the ones of the images 104. The relevance of these measurements is based on two assumptions. First, the tags 106 of two visually close images 104 are assumed to be similar when those tags 106 accurately describe the images 104. Second, tags 106 submitted by users (which tags 106 are assumed to be) are assumed to be relevant with a high degree of probability. Terms representing both of these assumptions are then utilized by the consistency algorithm 120 in a framework for determining the confidence scores 122.

In the following paragraphs, an example framework implemented by the consistency algorithm is described, including an optimization problem and an iterative method. This framework is provided simply as an example of the sort of framework that might be implemented by the consistency algorithm 120.

In the framework, the set of the images 104 is defined as D={x₁, x₂, . . . , xₙ}, where n is the number of images 104 and xₙ denotes an image 104 in the set of images 104. The set of unique tags 106 for the images 104 is defined as T={t₁, t₂, . . . , tₘ}, where m is the number of unique tags 106 and 4, denotes a tag 106. The initial associations of the unique tags 106 with the images 104 are defined by a binary matrix Ŷε{0, 1}^{n×m} whose element Ŷᵢⱼ indicates whether the tag tⱼ is associated with the image xᵢ. If tⱼ is associated with xᵢ, then Ŷᵢⱼ=1. If not, then Ŷᵢⱼ=0. The confidence scores 122 produced utilizing the framework are also stored in a matrix, Y, whose element Yᵢⱼ denotes the confidence score 122 for assigning the tag tⱼ to the image xᵢ. From the matrix Y, a confidence score vector for an i-th image can be derived and defined as y=(yᵢ₁, yᵢ₂, . . . , yᵢₘ)^{T}.

In computing the confidence scores 122 with the framework, the consistency algorithm 120 first computes visual similarity between images 104 based on low level features of the images. The computed visual similarity is defined by a similarity matrix W whose element Wᵢⱼ indicates the visual similarity between images xᵢ and xⱼ. Wᵢⱼ can be computed based on a Gaussian function with a radius parameter σ and can thus be defined as:

$${W}_{ij} = exp ( - \frac{{‖ {x}_{i} - {x}_{j} ‖}^{2}}{{σ}^{2}} )$$

where xᵢ and xⱼ denote low level features of the images being compared.

The consistency algorithm 120 then computes semantic similarity between tags 106 of the images 104 based on similarity metrics derived from a knowledge base, such as the WordNet™ knowledge base mentioned above. These similarity metrics are represented in a matrix S where the individual element Sᵢⱼ represents the semantic similarity between tags tᵢ and tⱼ. Sᵢⱼ is defined as:

$${S}_{ij} = \frac{2 \times IC ( lcs ( {t}_{i} , {t}_{j} ) )}{IC ( {t}_{i} ) + IC ( {t}_{j} )}$$

where IC( ) represents the information content of a tag tᵢ or tⱼ or of lcs (tᵢ, tⱼ), lcs (tᵢ, tⱼ) being the “least common subsumer” in the knowledge base that the similarity metrics are derived from, the “least common subsumer” being a “common ancestor” of the tags being compared (here, tᵢ and tⱼ) that has the maximum information content. Since the lcs( ) refers to a common ancestor, the framework assumes that the tags are related in some sort of hierarchy, such as the category hierarchy of categories 118. The knowledge base may provide an enhanced description of a tᵢ or tⱼ in the form of categories associated with the tag tᵢ or tⱼ. Using the similarity matrix S, the framework then defines the semantic similarity of images by a weighted dot product:

$${y}_{i}^{T} {Sy}_{j} = {\sum }_{k , l = 1}^{m} {Y}_{ik} {S}_{kl} {Y}_{jl}$$

Based on the assumptions above, the visual similarity Wᵢⱼ is expected to be close to the semantic similarity yᵢ^{T}Syⱼ. This leads to the following formulation:

$${min}_{Y} {\sum }_{i , j = 1}^{n} {( {W}_{ij} - {\sum }_{k , l = 1}^{m} {Y}_{ik} {S}_{kl} {Y}_{jl} )}^{2}$$

such that Yⱼₗ≧0, i,j=1, 2, . . . , n, and k,l=1, 2, . . . , m.

In some implementations, the framework of consistency algorithm 120 also defines a term to represent the second assumption—that user-defined tags are relevant with a high degree of probability. This term is represented by the minimization of:

$${\sum }_{j = 1}^{n} {\sum }_{l = 1}^{m} {( {Y}_{j , l} - {\hat{Y}}_{j , l} )}^{2} exp ( {\hat{Y}}_{j , l} )$$

Because Y_{j,l} may be smaller than 1 and Ŷ_{j,l} is restricted to 0 and 1, the framework introduces a scaling factor αⱼ for each image, such that the term representing the second assumption becomes:

$${\sum }_{j = 1}^{n} {\sum }_{l = 1}^{m} {( {Y}_{j , l} - {α}_{j} {\hat{Y}}_{j , l} )}^{2} exp ( {\hat{Y}}_{j , l} )$$

The formulation minimizing the difference between the visual and semantic similarity terms and the term representing the second assumption are then summarized by the framework into an optimization problem:

$${min}_{Y , α} L = {\sum }_{i , j = 1}^{n} {( {W}_{ij} - {\sum }_{k , l = 1}^{m} {Y}_{ik} {S}_{kl} {Y}_{jl} )}^{2} + C {\sum }_{j = 1}^{n} {\sum }_{l = 1}^{m} {( {Y}_{j , l} - {α}_{j} {\hat{Y}}_{j , l} )}^{2} exp ( {\hat{Y}}_{j , l} )$$

such that Yⱼₗ, αⱼ≧0, i,j=1, 2, . . . , n, k,l=1, 2, . . . , m, and C is a weighting factor used to modulate the two terms.

The optimization problem can also be written in matrix form as:

$${min}_{Y , D} L = {‖ W - {YSY}^{T} ‖}_{F}^{2} + C {‖ ( Y - D \hat{Y} ) ∘ E ‖}_{F}^{2}$$

such that Yⱼₗ, Dⱼⱼ≧0. The point-wise product of matrices is indicated by °. An element Eᵢⱼ of the matrix E represents the factor exp(Ŷ_{j,l}). D is an n×n diagonal matrix whose element Dⱼₗ=αⱼ.

In various embodiments, to solve the optimization problem and obtain the confidence scores 122, the consistency algorithm 120 utilizes an efficient iterative bound optimization method that is defined by the framework. To enable this, the framework bounds the optimization problem—defined as function L above—with an upper bound L′, where L′ is defined as:

$$L \leq {L}^{′} = {\sum }_{i , j = 1}^{n} ( \begin{matrix}{W}_{ij}^{2} + {\sum }_{l = 1}^{m} {{[ \tilde{Y} S {\tilde{Y}}^{T} ]}_{ij} [ \tilde{Y} S ]}_{il} \frac{{Y}_{jl}^{4}}{{\tilde{Y}}_{jl}^{3}} - \\ 4 {\sum }_{l = 1}^{m} {{W}_{ij} [ \tilde{Y} S ]}_{il} {\tilde{Y}}_{jl} - 2 {{W}_{ij} [ \tilde{Y} S {\tilde{Y}}^{T} ]}_{ij} + 4 {\sum }_{k = 1}^{m} {{W}_{ij} [ S {\tilde{Y}}^{T} ]}_{kj} log {\tilde{Y}}_{ik}\end{matrix} ) + C {\sum }_{j = 1}^{n} {\sum }_{l = 1}^{m} ( {Y}_{jl}^{2} - 2 {α}_{j} {\hat{Y}}_{jl} {\tilde{Y}}_{jl} ( log \frac{{Y}_{jl}}{{\tilde{Y}}_{jl}} + 1 ) + {α}_{j}^{2} {\hat{Y}}_{jl}^{2} ) exp ( {\hat{Y}}_{jl} )$$

where \tilde{Y} can be any non-negative n×m matrix.

The optimal solution for L′ is given by the following set of equations:

$$\{ \begin{matrix}{Y}_{jl} = {[ \frac{- C exp ( {\hat{Y}}_{jl} ) {\tilde{Y}}_{jl}^{3} + \sqrt{M}}{{4 [ \tilde{Y} S {\tilde{Y}}^{T} \tilde{Y} S ]}_{jl}} ]}^{\frac{1}{2}} , \\ {α}_{j} = \frac{{\sum }_{l = 1}^{m} {\tilde{Y}}_{jl} ( log {Y}_{jl} - log {\tilde{Y}}_{jl} + 1 )}{{\sum }_{l = 1}^{m} {\hat{Y}}_{jl}}\end{matrix}$$

where:

M=(Cexp(Ŷⱼₗ))²+8Uⱼₗ\tilde{Y}ⱼₗ⁴(2[W\tilde{Y}S]ⱼᵢ+CαⱼŶⱼₗexp(Ŷⱼₗ))

with Uⱼₗ=[\tilde{Y}S\tilde{Y}^{T}\tilde{Y}S]ⱼₗ.

Given the visual similarity matrix W, the semantic similarity matrix S and a weighting factor C (which may, in some implementations, be experimentally determined), the consistency algorithm 120 applies the efficient iterative bound optimization method to the set of equations providing the optimal solution to L′. Outputs of the method include the confidence scores 122, represented in matrix Y, and the scaling factor, α. In operation, the efficient iterative bound optimization method first randomly initializes Y and α to values satisfying the constraints for function L given above. The efficient iterative bound optimization method then performs the following operations until convergence:

1. Fix α, update Y using equation Yⱼₗ in the set of equations.

2. Fix Y, update α using equation αⱼ in the set of equations.

Once the consistency algorithm 120 has utilized the efficient iterative bound optimization method to produce the confidence scores 122, the refining module 110 may utilize those confidence scores 122 to determine subsets of tags 106, as described above. The confidence scores 122 may also indicate a strong association between an image 104 and tag 106, even though that tag 106 may not have been associated with the image 104 when the tags 106 and images 104 were received. Based on the confidence scores 122, then, the refining module 110 may add new tags 106 to a subset of tags 106 for an image 104. Also, based on the confidence scores 122, the refining module 110 may remove tags 106 not belonging to the subsets of tags 106.

As illustrated in FIG. 1, once the refining module 110 has determined the subsets of tags 106, a tag enriching module 112 (hereinafter “enriching module 112”) enriches the subsets of tags 106 by adding further tags 114 to the subsets of tags 106. The tags 114 added to the subsets of tags 106 may include one or both of synonyms of tags 106 belonging to the subsets of tags 106 or categories associated with tags 106 belonging to the subsets of tags 106. In some implementations, the synonyms may be found in a data store of synonyms 124, the data store of synonyms 124 specifying terms and the synonyms associated with each term. Such a data store of synonyms 124 may be retrieved or derived from a knowledge base or some other source. For example, if one of the tags 106 of a subset of tags 106 is “dog,”, the data store of synonyms 124 may specify “doggy,” “mutt,” and “puppy” as synonyms. These synonyms may then be added by the enriching module 112 as tags 114 of the image 104 that the tag 106 “dog” is associated with.

Besides synonyms, the enriching module 112 may also add categories associated with the tags 106 belonging to the subsets of tags 106. These categories may also be referred to as “hypernyms.” In some implementations, the associations between tags 106 and categories may be retrieved from a set of categories 126, such as categories retrieved or derived from a knowledge base. In one implementation, the categories 126 may be the same as categories 118 and may also comprise a category hierarchy of a knowledge base (e.g., WordNet™). In such an implementation, categories 126 for the tag 106 “dog” might include “canine,” “mammal,” “animal,” and “organism.” Each of these categories 118 may then be added by the enriching module 112 as tags 114 of the image 104 that the tag 106 “dog” is associated with.

In some implementations, after adding the tags 114 to the subsets of tags 106, the enriching module 112 may filter the collective tags 114 (which include both added tags 114 and subsets of tags 106). The collective tags are hereinafter referred to as “tags 114.” The enriching module 112 filters the tags 114 by utilizing each in an image search query and determining the number of image results received in response. Such an image query may be submitted to an image search service. If the number of image results meets or exceeds a threshold, then the tag 114 is retained. If the number of image results is less than the threshold, then the tag 114 is removed from the set of tags 114.

In various embodiments, upon completion of the operations of the enriching module 112, the computing device 102 provides the images 104 and tags 114 (which, again, include both the subsets of tags 106 and the added tags 114) to an image search service. If the image search service already has the images 104, then the computing device 102 simply provides the tags 114 and a specification of their associations with images 104 (e.g., an XML document) to the image search service. The image search service may be the same device as the computing device 102, as a device of the above-mentioned social network, as both, or as neither. An example implementation describing the use of the tags 114 by an image search service is shown in FIG. 6 and is described below with reference to that figure.

### Example Computing Device

FIG. 2 illustrates an example computing device, in accordance with various embodiments. As shown, the computing device 102 may include processor(s) 202, interfaces 204, a display 206, transceivers 208, output devices 210, input devices 212, and drive unit 214 including a machine readable medium 216. The computing device 102 further includes a memory 218, the memory storing at least availability the filtering module 108, the refining module 110, the enriching module 112, the images 104, and the tags 106/114.

In some embodiments, the processor(s) 202 is a central processing unit (CPU), a graphics processing unit (GPU), or both CPU and GPU, or any other sort of processing unit.

In various embodiments, the interfaces 204 are any sort of interfaces. Interfaces 204 include any one or more of a WAN interface or a LAN interface.

In various embodiments, the display 206 is a liquid crystal display or a cathode ray tube (CRT). Display 206 may also be a touch-sensitive display screen, and can then also act as an input device or keypad, such as for providing a soft-key keyboard, navigation buttons, or the like.

In some embodiments, the transceivers 208 include any sort of transceivers known in the art. The radio interface facilitates wired or wireless connectivity between the computing device 102 and other devices.

In some embodiments, the output devices 210 include any sort of output devices known in the art, such as a display (already described as display 206), speakers, a vibrating mechanism, or a tactile feedback mechanism. Output devices 210 also include ports for one or more peripheral devices, such as headphones, peripheral speakers, or a peripheral display.

In various embodiments, input devices 212 include any sort of input devices known in the art. For example, input devices 212 may include a microphone, a keyboard/keypad, or a touch-sensitive display (such as the touch-sensitive display screen described above). A keyboard/keypad may be a multi-key keyboard (such as a conventional QWERTY keyboard) or one or more other types of keys or buttons, and may also include a joystick-like controller and/or designated navigation buttons, or the like.

The machine readable medium 216 stores one or more sets of instructions (e.g., software) embodying any one or more of the methodologies or functions described herein. The instructions may also reside, completely or at least partially, within the memory 218 and within the processor(s) 202 during execution thereof by the computing device 102. The memory 218 and the processor(s) 202 also may constitute machine readable media 216.

In various embodiments, memory 218 generally includes both volatile memory and non-volatile memory (e.g., RAM, ROM, EEPROM, Flash Memory, miniature hard drive, memory card, optical storage (e.g., CD, DVD), magnetic cassettes, magnetic tape, magnetic disk storage (e.g., floppy disk, hard drives, etc.) or other magnetic storage devices, or any other medium). Memory 218 can also be described as computer storage media and may include volatile and nonvolatile, removable and non-removable media implemented in any method or technology for storage of information, such as computer readable instructions, data structures, program modules, or other data.

The filtering module 108, refining module 110, enriching module 112, images 104, and tags 106 and 114 shown as being stored in memory 218 are described above in detail with reference to FIG. 1.

### Example Operations

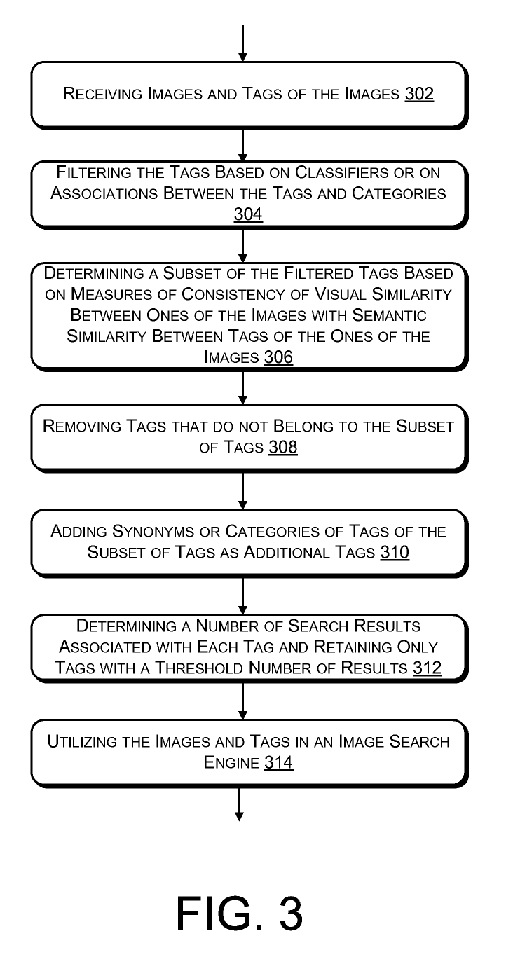

FIGS. 3-5 illustrate operations involved in filtering, refining, and enriching tags of images. These operations are illustrated in individual blocks and summarized with reference to those blocks. The operations may be performed in hardware, or as processor-executable instructions (software or firmware) that may be executed by one or more processors. Further, these operations may, but need not necessarily, be implemented using the arrangement of FIG. 1. Consequently, by way of explanation, and not limitation, the method is described in the context of FIG. 1.

FIG. 3 shows example operations for filtering image tags, determining a subset of image tags, and adding synonyms and categories of image tags as additional image tags, in accordance with various embodiments. As illustrated at block 302, the computing device 102 receives a plurality of images 104 and a plurality of tags 106 associated with the images 104. In some implementations, the receiving comprises receiving the images 104 and tags 106 from a repository of images 104 tagged by users. Also, the images 104 may either be still images 104 or frames 104 of a video.

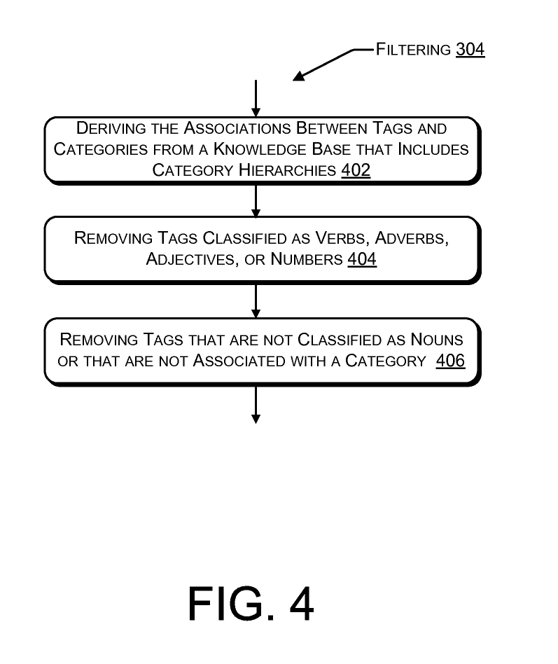

At block 304, the filtering module 108 of the computing device 102 filters the tags 106 based on at least one of classifications 116 of the tags or associations between one or more of the tags and one or more categories 118. In some implementations, the categories are derived from a knowledge base that includes one or more category hierarchies. Further details of the filtering operations are illustrated in FIG. 4 and described below in greater detail with reference to that figure.

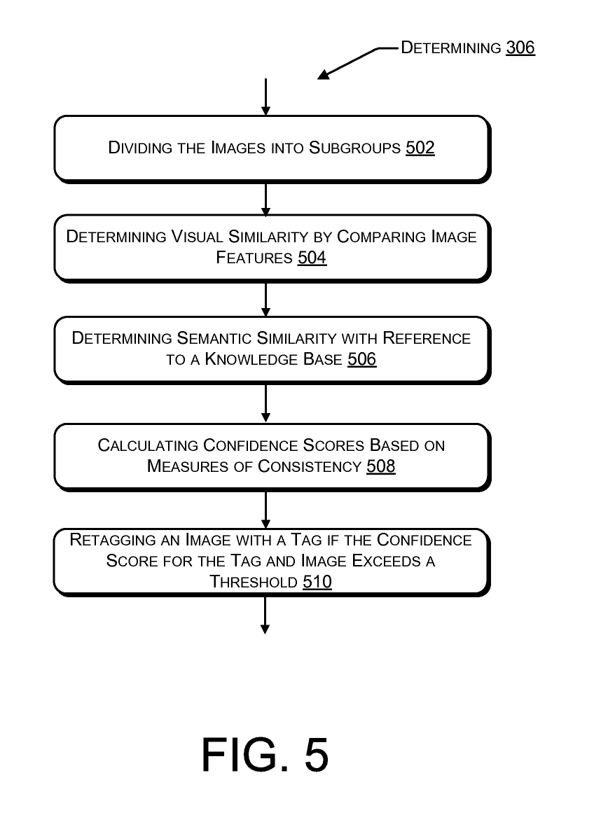

At block 306, the refining module 110 of the computing device 102 determines for at least one of the images 104 a subset of the tags 106 associated with the at least one image 104 based on one or more measures of consistency of visual similarity between ones of the images 104 with semantic similarity between tags 106 of the ones of the images 104. In some implementations, the measures of consistency are represented in a matrix relating unique tags 106 to images 104 and each measure of consistency is utilized as a confidence score 122 for assigning a specific tag 106 to a specific image 104. Also, the magnitudes of the measures of consistency may be inversely related to magnitudes of differences between the visual similarity and the semantic similarity. Additionally, the refining module 110 may, as part of determining the subset, determine tags 106 associated with other image(s) 104, those tags 106 being associated with image content of the at least one of the images 104 based on the measures of consistency. Such determined tags 106 may also be added to the subset of tags 106. Further details of the determining operations are illustrated in FIG. 5 and described below in greater detail with reference to that figure.

At block 308, the refining module 110 removes any of the plurality of tags 106 that do not belong to a subset of tags 106 determined by the computing device 102.

At block 310, the enriching module 112 of the computing device adds as tags 114 to the at least one image 104 at least one of synonyms 124 or categories 126 of tags belonging to the subset of filtered tags 106.

At block 312, the enriching module 112 determines a number of search results associated with each tag 114 and retaining only tags 114 associated with a threshold number of search results.

At block 314, the computing device 102 utilizes the images 104 and determined subsets of tags 114 for each of the images 104 in an image search engine of a search service or of a social network. An example implementation showing such utilizing is illustrated in FIG. 6 and described below with reference to that figure.

FIG. 4 shows example operations for filtering image tags by using classifiers and associations between tags and categories, in accordance with various embodiments. At block 402, the filtering module 108 derives the associations between tags 106 and categories 118 from a knowledge base that includes one or more category hierarchies.

At block 404, the filtering module 108 removes tags 106 classified as verbs, adverbs, adjectives, or numbers based on classifiers 116.

At block 406, the filtering module 108 removes tags 106 that are not classified as nouns and tags 106 that do not have an association with a category 118 derived from a knowledge base.

FIG. 5 illustrates a flowchart showing example operations for determining a subset of image tags based at least on consistency between visual similarity and semantic similarity, in accordance with various embodiments. At block 502, the refining module 110 divides the images 104 into a plurality of subgroups by a clustering algorithm. Operations 504-510 may then be performed on these images 104 and tags 106 in their subgroups.

At block 504, the consistency algorithm 120 of the refining module 110 determines visual similarity between images 104 by comparing features of the images 104, such as low level features.

At block 506, the consistency algorithm 120 determines semantic similarity between tags 106 with reference to a knowledge base providing an enhanced description of each tag 106.

At block 508, the consistency algorithm 120 calculates confidence scores 122 for assigning a specific tag 106 to a specific image 104 based both on the measures of consistency and on metrics giving higher weight to user-submitted tags.

At block 510, the refining module 110 retags the specific image 104 with the specific tag 106 of that specific image 104 if the confidence score 122 associated with the specific image 104 and specific tag 106 exceeds a threshold. As mentioned above, the specific image 104 may be “retagged” with a specific tag 106 of another image 104 if the confidence score associated with the specific image 104 and such a specific tag 106 exceeds a threshold.

### Example Implementation

FIG. 6 illustrates a block diagram showing an example implementation using the refined image tags in an image search service, in accordance with various embodiments. As illustrated, a computing device 102 communicates with a social network 602 and receives tagged images 604 from the social network 602. The computing device 102 then performs operations such as those illustrated in FIGS. 3-5 and described above to produce retagged images 606, which the computing device 102 provides to a search service 608. The search service 608 communicates with one or more clients 610, receiving image queries 612 from the clients 610 and providing image results 614 to the clients 610.

In various implementations, the social network 602 is any sort of social network known in the art, such as the Flickr™ image repository. As mentioned above with regard to FIG. 1, images 104 and associated tags 106 may be received from any source, such as a social network 602. These received images 104 and tags 106 may comprise the tagged images 604. The social network 602 may be implemented by a single computing device or a plurality of computing devices and may comprise a web site, a search service, a storage server, or any combination thereof. Also, as mentioned above with regard to FIG. 1, the social network 602 and computing device 102 may communicate via any one or more networks, such as WAN(s), LAN(s), or the Internet. In one implementation, the social network 602 and computing device 102 may be implemented in the same or related computing devices.

The computing device 102 may also communicate with the search service 608 via any one or more networks, such as WAN(s), LAN(s), or the Internet. In some implementations, these may be the same networks that are used by the computing device 102 to communicate with the social network 602. Also, in various implementations, the search service 608 may comprise a part of the social network 602. The retagged images 606 provided to the search service 608 may be the images 104 and tags 114 produced by the computing device 102 in the manner described above.

The clients 610 communicating with the search service 608 may be any sort of clients known in the art. For example, clients 610 may comprise web browsers of computing devices. The clients 610 may provide image queries 612 to the search service 608. These image queries may have been entered by a user through, for example, a web page provided by the search service 608. In response, the search service may perform an image search on the retagged images 606 using the tags 114 produced by the computing device 102. The search service 608 then provides image results 614 based on the image search to the clients 610. These image results 614 may be delivered, for instance, as a web page of ranked or unranked search results and may be displayed to users by the clients 610.

In some implementations, the search service 608 ranks the image results 614 based on the confidence scores 122 associated with the tags 114 of the retagged images 606. As discussed above with regard to FIG. 1, these confidence scores may measure the degree to which a tag is related to the visual content of the image. These confidence scores may be received by the search service from the computing device 102. Also, synonyms and categories added as tags 114 by the enriching module 112 may use the confidence scores 122 of the tags 106 as their confidence scores. These additional confidence scores for the synonym and category tags may be determined by the computing device 102 or the search service 608.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A method comprising:
receiving, by a computing device, a plurality of images and a plurality of tags associated with the images; and
determining, by the computing device, for at least one of the images a subset of the tags associated with the at least one image based on one or more measures of consistency of visual similarity between ones of the images with semantic similarity between tags of the ones of the images.

2. The method of claim 1, further comprising filtering the tags based on at least one of classifications of the tags or associations between one or more of the tags and one or more categories.

3. The method of claim 1, wherein the receiving comprises receiving the images and tags from a repository of images tagged by users.

4. The method of claim 1, wherein the determining comprises adding at least one of the plurality of tags to the subset of the tags based on the one or more measures of consistency, the added tag not being associated with the at least one image when the tags and images were received.

5. The method of claim 1, further comprising removing any of the plurality of tags that do not belong to a subset of tags determined by the computing device.

6. The method of claim 1, further comprising utilizing the images and determined subsets of tags for each of the images in an image search engine of a search service or of a social network.

7. The method of claim 1, wherein the measures of consistency are represented in a matrix relating unique tags to images and each measure of consistency is utilized as a confidence score for assigning a specific tag to a specific image.

8. The method of claim 7, further comprising retagging the specific image with the specific tag of that specific image if the confidence score associated with the specific image and specific tag exceeds a threshold.

9. The method of claim 7, further comprising calculating the confidence scores based both on the measures of consistency and on metrics giving higher weight to user-submitted tags.

10. The method of claim 1, further comprising:
determining visual similarity between images by comparing features of the images; and
determining semantic similarity between tags with reference to a knowledge base providing an enhanced description of each tag.

11. The method of claim 1, wherein magnitudes of the measures of consistency are inversely related to magnitudes of differences between the visual similarity and the semantic similarity.

12. The method of claim 1, further comprising computing the measures of consistency for each image of a subgroup of images, the plurality of images being divided into a plurality of subgroups by a clustering algorithm.

13. The method of claim 1, further comprising adding as tags to the at least one image at least one of synonyms or categories of tags belonging to the subset of filtered tags.

14. The method of claim 1, wherein the images are either still images or frames of a video.

15. A computer-readable memory device comprising executable instructions stored on the computer-readable memory device and configured to program a computing device to perform operations including:
filtering a plurality of tags associated with a plurality of images based on at least one of classifications of the tags or associations between one or more of the tags and one or more categories; and
determining for at least one of the images a subset of the filtered tags associated with the at least one image based on one or more measures of consistency of visual similarity between ones of the images with semantic similarity between filtered tags of the ones of the images.

16. The computer-readable memory device of claim 15, wherein the filtering further comprises removing tags classified as verbs, adverbs, adjectives, or numbers.

17. The computer-readable memory device of claim 15, wherein the associations between tags and categories are derived from a knowledge base that includes one or more category hierarchies.

18. The computer-readable memory device of claim 15, wherein the filtering comprises removing tags that are not classified as nouns and tags that do not have an association with a category derived from a knowledge base.

19. A system comprising:
a processor; and
a plurality of programming instructions configured to be executed by the processor to perform operations including:
filtering a plurality of tags associated with a plurality of image based on at least one of classifications of the tags or associations between one or more of the tags and one or more categories;
determining for at least one of the images a subset of the filtered tags associated with the at least one image based on one or more measures of consistency of visual similarity between ones of the images with semantic similarity between filtered tags of the ones of the images; and
adding as tags to the at least one image at least one of synonyms or categories of tags belonging to the subset of filtered tags.

20. The system of claim 19, wherein the categories are derived from a knowledge base that includes one or more category hierarchies.

21. The system of claim 19, wherein the operations further include, after performing the adding, performing a search to determine a number of search results associated with each tag and retaining only tags associated with a threshold number of search results.
